(19) United States
(12) Patent Application Publication
(10) Pub. No.: US 2011/0112980 A1
(43) Pub. Date: May 12, 2011

(54) METHOD AND DEVICE FOR PROCESSING INFORMATION

(75) Inventors: Eric Blot-Lefevre, Neuilly-sur-Seine (FR); Martin Lafon, Orsay (FR)

(73) Assignee: Trustseed SAS, Galluis (FR)

(21) Appl. No.: 12/524,897

(22) PCT Filed: Jan. 29, 2008
(86) PCT No.: PCT/IB2008/001105

§ 371 Date: Jun. 9, 2010

(30) Foreign Application Priority Data
Jan. 29, 2007 (FR) 07/00648

(51) Int. Cl. G06Q 10/00; G06F 17/00

(52) U.S. Cl. 705/342; 715/202

(57) ABSTRACT

An information processing method that includes the steps of determining a primary document having at least one definition of at least one secondary document related to the primary document, and creating a secondary document, the content of which automatically depends on the content of the primary document. In some embodiments, the primary document is associated with a time interval, and outside the time interval, the partially automatic creation of a secondary document is not authorized. In some embodiments, the content of the primary document defines the rights for the creation of a secondary document, and the process of creating a secondary document includes the step of checking the rights defined for the secondary document by the content of the primary document, and if the rights are not granted, the partially automatic creation of a secondary document is not authorized.

### CROSS REFERENCE TO RELATED APPLICATIONS

This application the U.S. National Phase application under 35 U.S.C. §371 of International Application No. PCT/IB2008/001105, filed Jan. 29, 2008, and claims the benefit of French Patent Application No. 07/00648, filed Jan. 29, 2007, all of which are incorporated by reference herein. The International Application was published on Aug. 7, 2008 as WO 2008/093245.

### FIELD OF INVENTION

The present invention relates to a method and a device for processing information. It applies in particular to the dematerialization of documents with legal and/or probative value.

### BACKGROUND

The current document management systems are intended for use by a single entity, for example a company. They are based on a management of rights to a document (to edit, to sign, for example) but do not allow complex processing of the document by a set of operatives, for example in order to dematerialize documents.

The present invention aims to remedy these drawbacks.

Summary of Invention To this end, an embodiment of the present invention aims, according to a first aspect, for an information processing method, characterized in that it comprises:
a step of determining the content of a so-called primary document comprising at least one definition of at least one so-called “secondary” document associated with said primary document and
a step of creating a secondary document, the content of said secondary document automatically depending on the content of the primary document.

Thanks to these provisions, the creation of the secondary documents is partially automatic and intuitive. In particular, the structure of the primary document enables its intuitive management, and a standardization of the secondary documents. As a consequence, the intervention of numerous service providers and the implementation of numerous applications for processing the management operation represented by each slip are facilitated.

According to particular characteristics, during the step of determining the content of the primary document, the primary document is associated with a time interval and, outside this time interval, the at least partially automatic creation of a secondary document is not authorized.

Thanks to these arrangements, the creator of the primary document can define a lifespan for this document.

According to particular characteristics, the content of the primary document defines creation rights for a secondary document and the step of creating a secondary document comprises a step of checking compliance with the rights defined, for said secondary document, by the content of the primary document and, in the event of noncompliance of these rights, the at least partially automatic creation of a secondary document is not authorized.

According to particular characteristics, said rights define at least one person authorized to generate a secondary document.

According to particular characteristics, during the step of creating a secondary document, each secondary document is assigned a common identifier with the primary document.

According to particular characteristics, during the step of determining the content of the primary document, at least one secondary document model is determined, represented by the content of the primary document and, during the step of creating a secondary document, the secondary document complies with a document model defined by the content of the primary document.

According to particular characteristics, during the step of determining the content of the primary document, a so-called associated primary model is applied, in a predetermined manner, to at least one secondary document model.

According to particular characteristics, during the step of determining content of the primary document, for each type of secondary document likely to be created, a number of secondary documents of this type is defined and represented by the content of the primary document and, during the step of creating a secondary document, a check is carried out to ensure that, for the type of secondary document to be created, said number has not been exceeded.

According to particular characteristics, during the step of determining the content of the primary document, at least one pair formed by a typical event and a typical form is determined, each said pair defining the form complied with by a secondary document generated for said typical event.

According to particular characteristics, each pair formed by a typical event and a typical form specifies the object of the secondary document, the processing to be carried out in relation to said secondary document.

For example, the pair specifies the usage context of the form (what part of the form for what event), and when a typical document is implemented, this typical document is included in the form. It will be noted that one and the same form can be used for a plurality of typical events and that the same form is used throughout one and the same process and enriched, that is, documented, at each step, by the result returned by the processing of that step.

According to particular characteristics, during the step of determining the content of a primary document, the primary document comprises at least one slip representative of a process relating to a management deed that can be initiated and a counterfoil representing an identifier common to all the slips of the document and, in the step of creating a secondary document, said slip is applied.

According to particular characteristics, the application of said slip initiates the transmission of a message to a computer application, the message including an event that defines the meaning of the message and consequently the process to be applied.

According to particular characteristics, said message represents a form that combines all the information necessary to implement a process, by all the computer applications likely to be implemented in relation to the primary document.

Thanks to these arrangements, the structure of the document allows for its intuitive management, the structure of the slip and the structure of the message allow for a standardization of the messages and consequently the intervention of numerous service providers and of numerous applications for processing the management operation represented by each slip.

According to particular characteristics, the method as briefly explained hereinabove includes a step of transmission, by said application, when it has completed the process, of another message to another computer application, this other message including an event that defines the meaning of this other message and consequently the process to be applied, and said form.

Thus, the form is not modified but is transmitted from one application to the next, which ensures the correct execution of the applications.

According to particular characteristics, the form comprises a typical document associated with the user. Thanks to these arrangements, the particular form of the document that the user wants to use can be specified and implemented by the computer application.

According to particular characteristics, the method as briefly explained hereinabove includes, to implement the step of using a slip, a step of displaying a management office, the work space in which the user can carry out management deeds and a step of displaying a mail office, in which the user can obtain reports of operations carried out in accordance with his instructions or operations that concern him and access a log of these operations.

According to particular characteristics, the method as briefly explained hereinabove comprises a step of transmitting a certificate of conformity to the mail office, by each application involved in an operation of a process initiated by a slip.

According to particular characteristics, the method as briefly explained hereinabove includes, for a slip for dematerializing a document:
a step of transmitting an original document,
a step of conserving the original in a secure memory,
switching step, that is, a step of duplicating the original in a memory assigned to the issuing user and in a memory assigned to each recipient and
a step of certified copying, that is to say placing in an envelope, electronic or paper, each copy of the original assigned to a recipient.

According to particular characteristics, during the step of determining the content of a document, a nomenclature is set up, comprising all the components of the common language used for all the messages exchanged in relation to this document.

According to particular characteristics, the nomenclature consists of typical events, typical forms and typical documents.

According to particular characteristics, an event represents one of the following management acts:
a production order,
an original issue,
an invoice acceptance,
an acknowledgement of receipt, or
a payment order.

According to particular characteristics, during the lifespan of the document, the form is documented at each step of the process by the result of the processing of said step.

According to particular characteristics, during the step of determining the content of the document, reference is made to a typical document that defines the structure of the document, the authorizations and the management decisions, or slips, attached to the document.

According to a second aspect, the present invention targets an information processing device that comprises:
a step of determining the content of a so-called primary document comprising at least one definition of at least one so-called “secondary” document associated with said primary document and
a step of creating a secondary document, the content of said secondary document automatically depending on the content of the primary document.

According to a third aspect, the present invention targets an information processing method, characterized in that it comprises:
a step of determining the content of a so-called primary document comprising at least one definition of at least one so-called “secondary” document associated with said primary document and
a step of creating, by a user, a secondary document, the content of said secondary document depending on the content of the primary document.

Since the advantages, aims and particular characteristics of this device and of this method that is the subject of the second and third aspects are similar to those of the method that is the subject of the first aspect, as briefly explained hereinabove, they are not reviewed here.

### BRIEF DESCRIPTION OF DRAWINGS

Other advantages, aims and characteristics of the present invention will emerge from the following description, given for explanatory reasons and in a by no means limiting way, in light of the appended drawings in which:

FIG. 1 diagrammatically represents a model implemented in a particular embodiment of the method and of the devices that are the subject of the present invention,

FIGS. 2A and 2B diagrammatically represent elements defined in a nomenclature implemented in a particular embodiment of the method and of the devices that are the subject of the present invention,

FIG. 3 diagrammatically represents a flow of messages implemented in a particular embodiment of the method and of the devices that are the subject of the present invention,

FIGS. 4A and 4B diagrammatically represent a block plan implemented in a particular embodiment of the method and of the devices that are the subject of the present invention,

FIG. 5 represents a succession of messages exchanged to make a payment,

FIG. 6 is a flow diagram representing the steps implemented in a particular embodiment of the method that is the subject of the present invention and

FIG. 7 is a flow diagram representing the steps implemented in a particular embodiment of the method that is the subject of the present invention.

### DETAILED DESCRIPTION

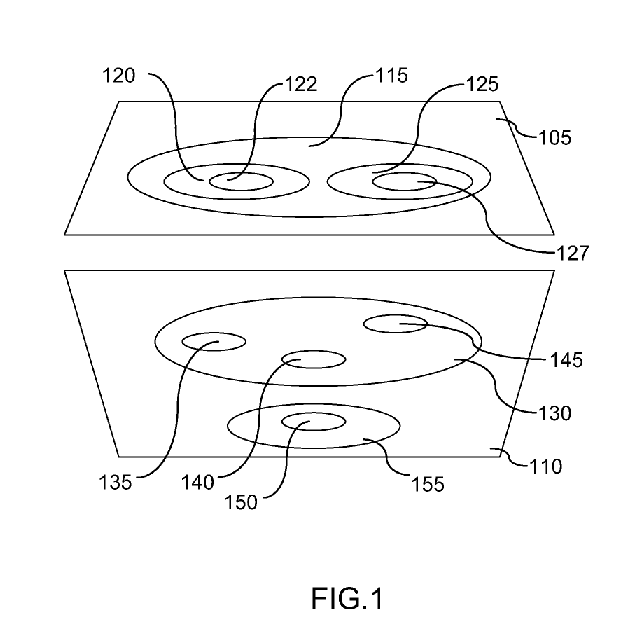

As illustrated in FIG. 1, two sets of operators act on behalf of a user, also called “member”:
a trusted third-party network 105, which is responsible, with respect to the user, for the correct completion of the operations that he requests and
a set of operators 110 which execute the dematerialization tasks.

The trusted third-party network 105 provides all the elements with which to give a legal or probative value to a management decision of a user and, in particular to:
the transmission, by the user, of a document to a recipient or
the payment order of an invoice.

The user has an office 115 which serves interface with the trusted third-party network 105 and which takes the form of pages that can be displayed on a computer screen. The office 115 notably comprises a management office 120 in which the user can give instructions and a mail office 125 in which the user can obtain reports 127 of operations carried out in accordance with his instructions on operations that concern him and access a log of this operations.

The management office 120 is a work space of the user in which the user can carry out management acts. It is managed by the trusted third-party network 105.

The mail office 125 is a work space of the user which traces the results of the dematerialization operations, that is to say, the reports of operations. It is managed by the trusted third-party network 105.

A plurality of management and mail offices can be assigned by one and the same management operation initiated by a user. For example, when a supplier is paid, the management office and the mail office of each party, the user initiating the payment and the supplier being paid, are assigned.

Hereinafter in the description, interest will be focused on the management decisions implementing a document, that is to say, a unit produced by a system for dematerializing a file, a set of documents, managed by a user.

The management office issues slips 122, which are simplified auxiliary documents and which comply with the management deeds that can be activated during the life cycle of a document. A slip is linked to a counterfoil, that is to say, a common identifier for the slips associated with one and the same document.

A file comprises a plurality of documents, each document comprises a plurality of slips. The pairing process consists in bringing together the various documents of one and the same file according, for example, to the following hierarchy: company-user-file-document-slip.

The transmission of a slip from the management office 120 to an operator 110 provokes, in a mail account 130, that is to say, a work space of the user which, among other things, traces the results of the dematerialization process, managed by an operator, a step of issuing 135 an original document, a step 150 of retaining the original 155 in a secure memory, a switching step 140, that is to say, a step of duplicating the original in a memory assigned to the issuing user and in a memory assigned to each recipient and an certified copying step 145, that is to say, the placing in an envelope, electronic or paper, of each copy of the original assigned to a recipient. Each of these steps gives rise to an execution report, or certificate of conformity, sent to the mail office 120 of the issuing user.

For all the steps to proceed safely, the trusted third-party network 105 and the operators 110 use a common language represented by a nomenclature, all of the components of the common language used for all the exchanges in the trusted third-party network 105. The nomenclature consists of typical events, typical forms and typical documents. A message is a medium for circulating information between the components of the information system. A message is made up of two parts: the event and the form.

A typical event defines the meaning of the message, for example production order, original issue, invoice acceptance, acknowledgement of receipt or payment order. A form combines all the information needed for the processing operations performed by the applications affiliated to the trusted third-party network 105.

The pair formed by a typical event and a typical form fully defines each flow of information that circulates in the computer system. In practice, this pair specifies the subject of the message, the processing operation required, the context of use of the form (what part of the form for what event, when a typical document is needed, this typical document is included in the form. It will be noted that one and the same form can be used for a plurality of typical events and that the same form is used throughout one and the same process and added to, that is to say, documented at each step by the result returned by the processing of that step.

A typical document accompanies the form to specify the management deeds than can be initiated during the life of the file. The typical document defines the structure of the transaction document, and the authorizations and the management decisions, or slips, attached to the document.

It will be noted that the slips represent the tasks to be carried out on the document but that the trusted third-party network 105 does not impose any order of execution or completion of the tasks, this responsibility being transferred to the user's system.

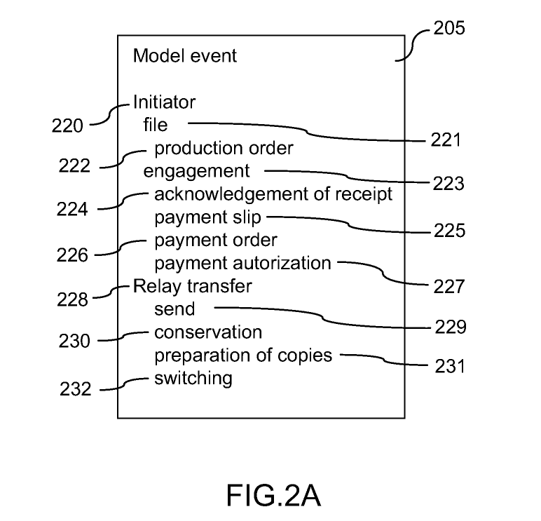

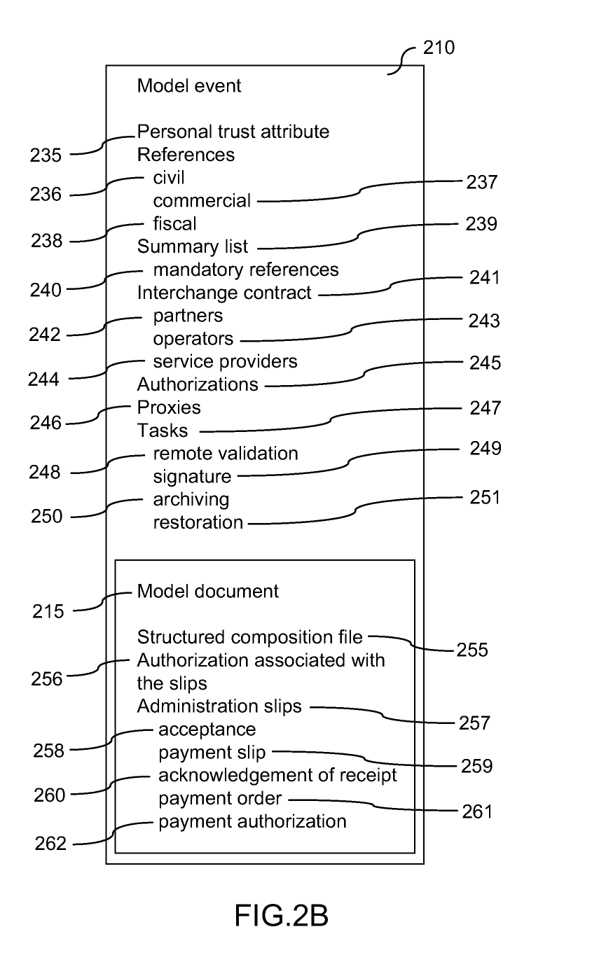

FIGS. 2A and 2B illustrate an example of typical event 205, of typical form 210 including a typical document 215.

The typical event 105 represents:
an initiator 220 (that is to say, an identifier of the user, including his parent company that has directly or indirectly provoked the issuing of the message),
a file 221 of this initiator,
a production order 222 for this file,
an engaging 223 of the initiator,
an acknowledgement of receipt 224 of this engagement,
an order to pay 225 for this engagement,
a payment order 226 for this engagement,
a payment authorization 227 for this engagement,
a relay transfer 228 giving the slip, like the initial document, a message and a form,
an issuing 229 of this relay transfer, that is to say, of the elements
associated with the slip, to the operator,
a conservation 230 of this relay transfer,
an certified copying 231 of this relay transfer, and
a switching 232 of this relay transfer.

Outside the typical document 215, the typical form 210 comprises:
a personal trust attribute 235,
civil references 236,
commercial references 237,
tax references 238,
a summary list 239,
mandatory references 240 from the summary list,
an interchange convention 241,
partners 242 to this interchange convention,
operators 243 of this interchange convention,
service providers 244 of this interchange convention,
authorizations 245,
proxies 246,
tasks 247,
remote validation 248 of the tasks 247,
a signature 249 for the tasks 247,
archiving 250 of the tasks 247 and
restoration 251 of the tasks 247.

The typical document 215 comprises:
a structured document composition file 255,
an authorization associated with the slips 256,
slips 257,
an acceptance slip 258,
a payment slip 259,
an acknowledgement of receipt slip 260,
a payment order slip 261 and
payment authorization slip 262.

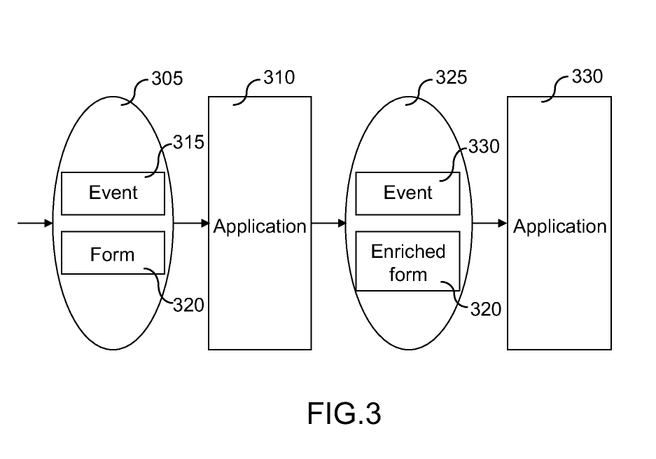

It can be seen, in FIG. 3, that, on initiation by an initiator, a slip is detached and provokes the issuing of a message 305 to an application 310 beginning a process associated with the processing of the slip. This message 305 includes an event 315 and a form 320, the event type, the form and any typical document incorporated in the form 320 being defined by the independent nomenclature of the reference base.

Once the message 305 is received by the application 310, the application 310 processes the event 315 and enriches, that is to say documents, the form 320 with the results of the application 310 before handing over, that is to say sending another message 325 intended for another application 330, this other message 325 including an event 330 and the enriched form 320.

The processing operations and issuing of messages thus continue until the slip has been fully processed.

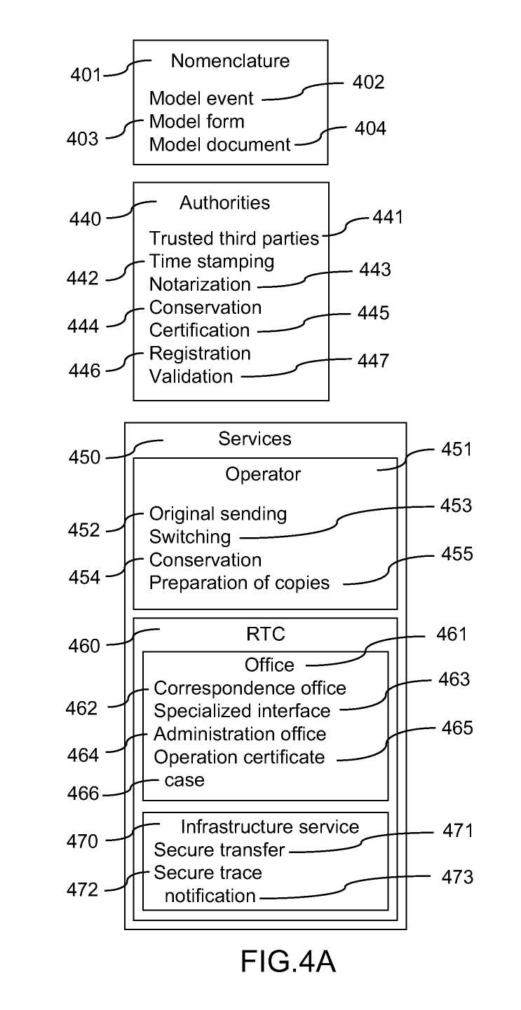

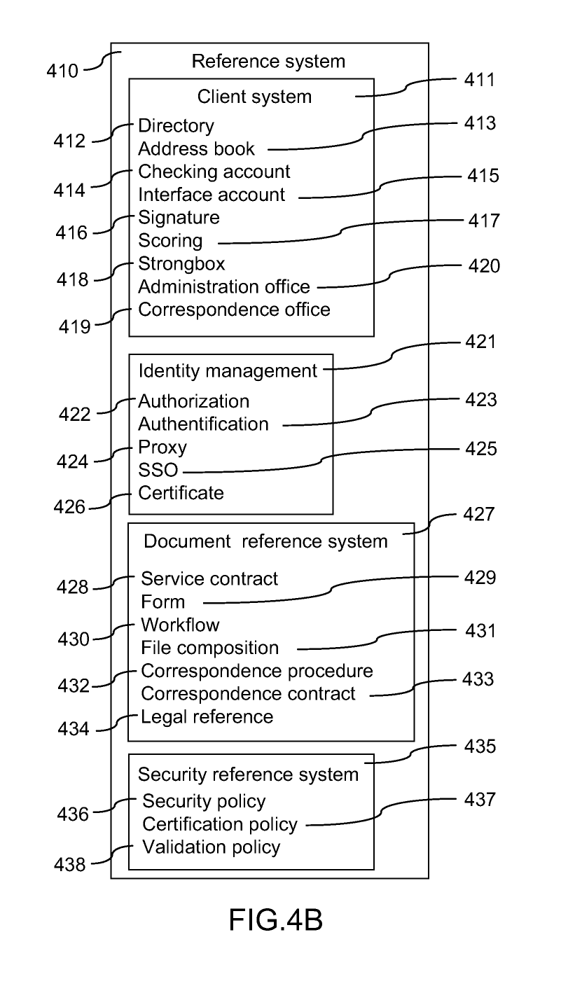

FIGS. 4A and 4B show a nomenclature 401, a reference base 410, authorities 440 and services 450. The nomenclature 401 defines each typical event 402, each typical form 403 and each typical document 404. The reference base 410 is a unique reference base managed by the trusted third-party network and shared by all the operators and trusted third parties. The reference base 410 comprises a customer reference base 411, and identity management reference base 421, a document reference base 427 and a security reference base 435. The reference base of each user, or client, 411 comprises a directory 412 which centralizes the referencing of the users, an address book of the user 413 associated with the setting up of the user, a mail charge account 414 which defines the mail account, an interface account 415 which defines the interface accounts with the service providers, financiers, for example, a signature 416, digitized file attached to each user, a notation 417 associated with the setting up of the user, a strong-box definition 418 attached to each user, a management office 419 and a mail office 420.

The management reference base of each identity 421 combines the identification and authorization means of the users. The reference base 421 comprises an authorization 422, which describes the rights of the users, for example the functions and documents that they can manage, an identity 423, for example a mobile telephone number, with which to authenticate a user by sending him a single-usage password on a communicating mobile terminal, a proxy 424 from the user to the operator for the operator to sign documents in the name of the user, an SSO 425, means of propagating the identity and the authorizations of a user, and a certificate 426, for example conforming to the public key infrastructure (PKI).

The document reference base of each user 427 combines all the contractual documents associated with a user. The reference base 427 includes a service contract 428, entered into between the trusted third-party network and the user, a form 429, a work flow definition 430, a structured file composition 431, a mail procedure 432 which defines the operating mode between the user, the trusted third-party network and the operators, a mail convention 433 and a legal reference 434. It will be noted that the trusted third-party network takes responsibility only for the production work flows, that is to say, the dematerialization system and the supply to the offices and the accounts. On the other hand, the trusted third-party network does not take responsibility for the decisional processes, for example invoice payment validation, which are associated with the production systems of the users. The trusted third-party network provides the users with a management office for matching (that is to say, associating an external justification of the counterpart of an internal operation, a matching being a document produced by this justification, associated with a slip in response to a question slip) their management decisions on dematerialized data with legal/probative value. The trusted third-party network also manages the meeting points in the form of notifications, when a plurality of users participate in a joint decision.

The security reference base of each user 435 includes a security policy 436, which defines the constraints of the trust domain of the trusted third-party network, a certification policy 437, which concerns the servers in the trust domain of the trusted third-party network and a validation policy 438, a method of accepting certificates from the servers of the trust domain of the trusted third-party network and outside this domain.

In the embodiment illustrated in FIGS. 4A and 4B, the trusted third-party network is a hierarchical network matched to an infrastructure conforming to the PKI infrastructure. A root trust third party is the root of the certification authority. An affiliated trusted third party is under the certification authority. A certification sub-authority can, in turn, issue certificates for his own internal authorities. A certification sub-authority can also issue certificates to its own trusted sub-third-parties. The trust domain can be extended by cross-agreement with other trusted roots. It corresponds to the putting in place of the validation authority to be used, among other things, to accept the roots outside the trusted domain.

The authorities 440 comprise at least a trusted third party 441, a time stamp provider 442, a notarization service provider 443, a conservation service provider 444, a certification authority 445, a registration service provider 446 and a validation service provider 447. The certification authority 445 issues and manages the lifecycle of the certificates issued to the trusted third parties. The time stamping provider 442 provides a signed time to be incorporated in each transaction. The notarization service provider 443 certifies a transaction between two partners. The registration service provider 446 handles the registration of the users with the trusted third party and the registration of the servers of the trusted system. The conservation service provider 444 protects the archived documents and uses the time stamping authority to mark the time. The validation service provider 447 validates a certificate external to the trusted domain of the trusted third-party network.

The services 450 comprise operators 451 and members of the trusted third-party network 460. The operators 451 comprise original issue operators 452, switching operators 453, conservation operators 454 and certified copying operator 455.

The trusted third-party network 460 comprises offices 461 and infrastructure services 470. The offices 461 include a secure mail office 462, a job interface 463, a collaborative management office 464, operation certificates 465 and business contracts 466. A business contract is a set of files associated manually by a user. The infrastructure services 470 combine the transport, traceability and notification tools. They include a secure transfer service 471, which transfers data from the clients to the data center and to organizations, a secure trace service 472, which provides a technical or functional trace that cannot be altered, the integrity of which is assured, and a notification service 473, which takes responsibility for all the methods of notifying the users, by electronic mail, a short message, alerts in a portal and by multiple-partner synchronization.

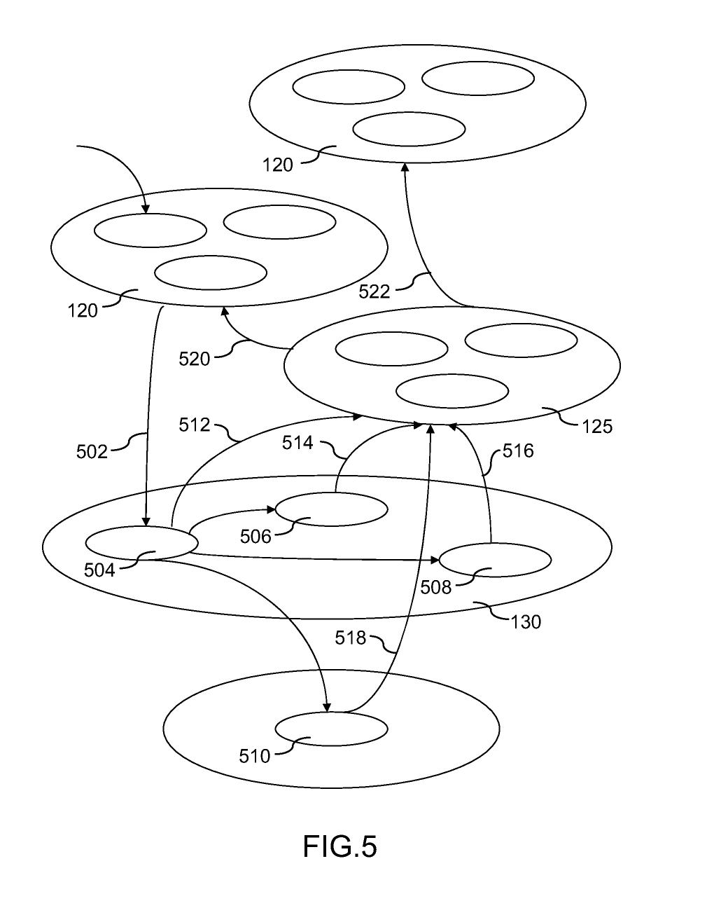

FIG. 5 shows that a paying user first gives a payment order, creating a slip, in his management office, step 502. Then, a dematerialization method is transmitted to an operator, who issues the corresponding original document, step 504. Then, one or more operators perform the switching 506, certified copying 508 and conservation 510 steps, and return, for the performance of each of these steps, a certificate of conformity to the mail office of the paying user, steps 512, 514, 516 and 518, respectively. The mail office of the paying user then issues a message to the management office of the user client, step 520, and of the paid provider, step 522.

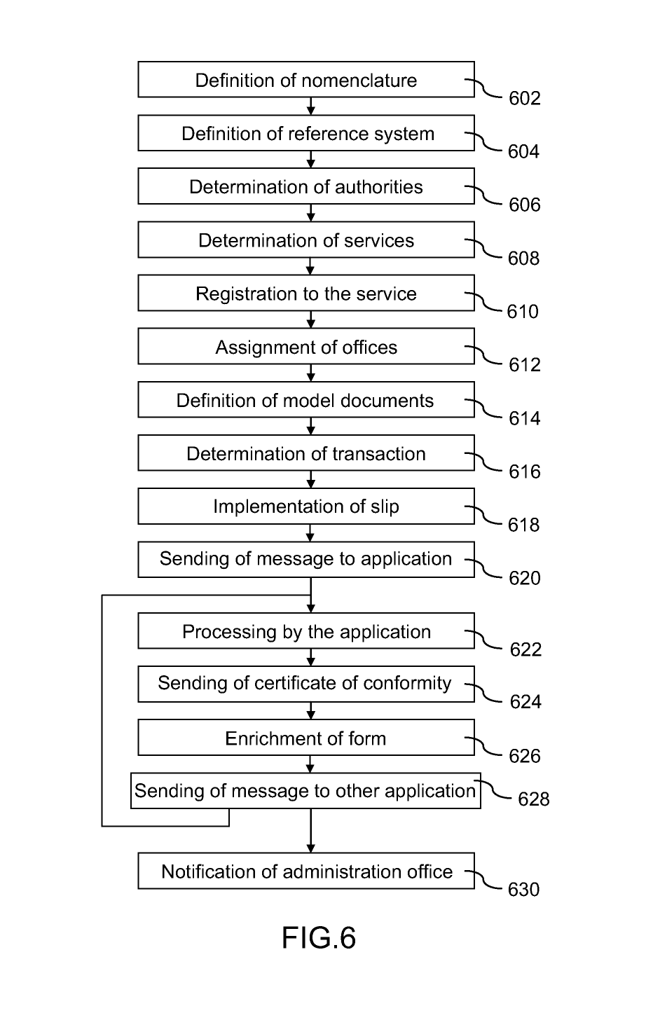

FIG. 6 shows a step 602 for defining a nomenclature, a step 604 for defining a reference base, a step 606 for determining authorities and a step 608 for determining the services implemented.

Thus, during a step 610, a user joins up for services of the trusted third-party network, and is assigned a management office and a mail office, step 612. During a step 614, the user defines typical documents that he will use.

During a step 616, the user determines a transaction that he wants to perform. During a step 618, the user uses a slip included in the document. During a step 620, a message is sent to an operator computer application responsible for the first slip processing operation, this message including an event and a form.

During a step 622, the application performs the processing for which it is responsible. During a step 624, the application sends a certificate of conformity to the mail office of the user who has used the slip. During a step 626, the application enriches the form with the result or results of its processing of the slip. During a step 628, the application sends a message to another application responsible for the continuation of the processing of the slip, and so on.

When the processing of the slip is completed, during a step 630, the mail office notifies the management office of each user affected by the processing of the slip.

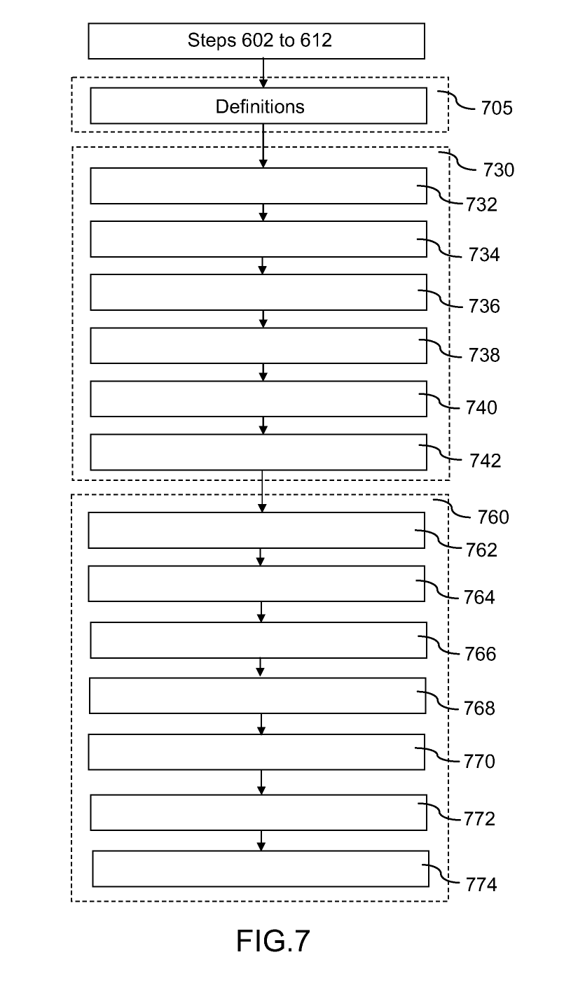

As can be seen in FIG. 7, in a particular embodiment, the information processing method that is the subject of the present invention essentially comprises three phases:
a phase 705 of definition of typical documents, document models, forms and pairs associating events with forms,
phase 730 of determining the content of a so-called primary document including at least a definition of at least one so-called “secondary” associated with said primary document and
a phase 760 of creating a secondary document, the content of said secondary document automatically depending on the content of the primary document.

Prior to the phase 705, the steps 602 for defining a nomenclature, 604 for defining a reference base, 606 for determining authorities, 608 for determining the services implemented, 610 for a user to join up to the services of the trusted third-party network, and 612 for assignment of a management office and a mail office to the user are carried out.

During the phase 705, the user defines so-called “primary” typical documents or primary document models, that he wants to use and so-called “secondary” typical documents that are likely to be linked thereto. Thus, at least one secondary document model likely to be represented by the content of a primary document is determined.

The phase 730 first comprises a step 732 for selection, by a user, of a primary document type. Then, during a step 734, a primary document is associated with a time interval. Thus, the creator of the primary document can define a lifespan for this document. During a step 736, the user documents the primary document, originating from the typical primary document, for its content to define secondary document creation rights. For example, the rights define at least one person or a computer application authorized to generate a secondary document. During a step 738, the primary document will have assigned to it at least one identifier which will be common with the secondary documents deriving from the primary document.

During a step 740, for each secondary document type likely to be created, a number of secondary documents of this type is defined and represented by the content of the primary document.

Preferably, during a step 742, automatically, based on the primary document model used, at least one pair formed by a typical event and a typical form is determined, complied with each so-called pair defining the form by a secondary document generated for said typical event. For example, each pair formed by a typical event and a typical form specifies the subject of the secondary document and the processing to be carried out in relation to said secondary document. For example, the pair specifies the usage context of the form (what part of the form for what event), and when a typical document is implemented, this typical document is included in the form.

It will be noted that one and the same form can be used for a plurality of typical events and that the same form is used throughout one and the same process and enriched, that it is to say documented, in each step, by the result returned by the processing of that step.

Preferably, the primary document includes at least one slip representative of a process relating to a management deed that can be initiated and a counterfoil representing an identifier common to all the slips of the document.

In embodiments, the form includes a typical document associated with the user. Thus, the particular form of the primary document that the user wants to use can be specified and implemented by the computer application.

The phase 760 includes, first of all, a step 762 for initiating the creation of a secondary document. For example, the step 762 includes the detection of the occurrence of an event defined by a pair associated with the primary document.

Then, during a step 764, a secondary document is created. Any form associated with the event is complied with by the secondary document generated for said typical event. The typical form specifies the subject of the secondary document and the processing to perform in relation to said secondary document. For example, the pair specifies the usage context of the form (what part of the form for what event), and when a typical document is implemented, this typical document is included in the form. It will be noted that one and the same form can be used for a plurality of typical events and that the same form is used throughout one and the same process and enriched, that is to say documented, at each step, by the result returned by the processing of that step. For example, the pair specifies the usage context of the form (what part of the form for what event), and the secondary document complies with the constraints of the form.

The secondary document complies with a document model defined by the content of the primary document; a secondary document model is implemented, associated with a primary document model.

During a step 766, where appropriate, a determination is made as to whether the present moment lies within the time interval associated with the primary document. If not, that is to say outside the time interval associated with the primary document, the at least partially automatic creation of a secondary document is not authorized.

During a step 768, a check is carried out to ensure compliance with the rights defined, for said secondary document, by the content of the primary document and, if these rights are not complied with, the at least partially automatic creation of a secondary document is not authorized.

During a step 770, the secondary document is assigned an identifier in common with the primary document.

During a step 772, a check is carried out, for the secondary document type to be created, to ensure that the number of documents authorized by the content of the primary document has not been exceeded. If it has been exceeded, the creation of the secondary document is stopped.

In the case where a slip is used that is representative of a process relating to a management act that can be initiated and a counterfoil representing an identifier common to all the slips of the document, during a step 774, the use of the slip, initiates the issuing of a message, or secondary document, to a computer application, the message including an event that defines the meaning of the message and, consequently, the process to be applied. This message, or secondary document, represents a form that combines all the information needed to implement a process, by all the computer applications likely to be used in relation to the primary document.

Thanks to these arrangements, the structure of the document makes its intuitive management possible, the structure of the slip and the structure of the message allow for a standardization of the messages and, consequently, the intervention of numerous service providers and numerous applications for the processing of the management operation represented by each slip.

When the application has completed the process, the application issues another message, or secondary document, to another computer application, this other message including said form and an event that defines the meaning of this other message and, consequently, the process to be applied. Thus, the form is not modified but is documented and transmitted from one application to the next, which ensures the correct execution of the applications.

Since other aspects of the implementation of the slips have already been described hereinabove, they will not be recalled with reference to FIG. 7.

It will be seen that the messages, secondary documents, are used to create other secondary documents. As a variant, it is the same application that handles the different processes associated with a primary document, the secondary documents being generated by the use of this application.

As an example, with the primary document being an invoicing counterfoil, it defines when, who (through authorization) and in what conditions, can generate the following secondary documents: an invoice, a credit note and a payment order, partial or total. These secondary documents are defined in conjunction with the primary document.

Thanks to these arrangements, the creation of the secondary documents is partially automatic and intuitive. In particular, the structure of the primary document allows for its intuitive management, and a standardization of the secondary documents. Consequently, the intervention of numerous service providers and the implementation of numerous applications for the processing of the management operation represented by each slip are facilitated.

Thanks notably to the implementation of the slips, the structure of the document allows for its intuitive management, the structure of the slip and the structure of the message allow for a standardization of the messages and, consequently, the intervention of numerous service providers and numerous applications for the processing of the management operation represented by each slip.

1. A method of processing information, characterized in that it comprises:
a step for determining the content of a so-called primary document including at least one definition of at least one so-called “secondary” document linked to said primary document and
a step for creating a secondary document, the content of said secondary document automatically being dependent on the content of the primary document.

2. The method as claimed in claim 1, characterized in that, during the step for determining the content of the primary document, the primary document is associated with a time slot and, outside this time slot, the at least partially automatic creation of a secondary document is not allowed.

3. The method as claimed in any one of claim 1 or 2, characterized in that the content of the primary document defines rights to create a secondary document and, the step for creating a secondary document includes a step for checking that the defined rights are observed, for said secondary document, by the content of the primary document and, if these rights are not observed, the at least partially automatic creation of a secondary document is not allowed.

4. The method as claimed in claim 3, characterized in that said rights define at least one person authorized to generate a secondary document.

5. The method as claimed in any one of claims 1 to 4, characterized in that, during the step for creating a secondary document, each secondary document is assigned an identifier in common with the primary document.

6. The method as claimed in any one of claims 1 to 5, characterized in that, during the step for determining the content of the primary document, at least one secondary document model is determined, represented by the content of the primary document and, during the step for creating a secondary document, the secondary document observes a document model defined by the content of the primary document.

7. The method as claimed in claim 6, characterized in that, during the step for determining the content of the primary document, a so-called primary model is implemented that is associated, in a predetermined manner, with at least one secondary document model.

8. The method as claimed in any one of claims 1 to 7, characterized in that, during the step for determining the content of the primary document, for each type of secondary document likely to be created, a number of secondary documents of this type is defined and represented by the content of the primary document and, during the step for creating a secondary document, a check is made to ensure that, for the type of secondary document to be created, said number has not been exceeded.

9. The method as claimed in any one of claims 1 to 8, characterized in that, during the step for determining the content of the primary document, at least one pair formed by a typical event and a typical form is determined, each said pair defining the form observed by a secondary document generated for said typical event.

10. The method as claimed in claim 9, characterized in that each pair formed by a typical event and a typical form specifies the object of the secondary document, the processing to be carried out in relation to said secondary document.

11. The method as claimed in any one of claims 1 to 10, characterized in that, during the step for determining the content of a primary document, the primary document includes at least one coupon representative of a process relating to a management act that it is possible to initiate and a stub representing an identifier in common with all the coupons of the document and, during the step for creating a secondary document, one of said coupons is implemented.

12. The method as claimed in claim 11, characterized in that the implementation of said coupon initiates the issuing of a message addressed to a computer application, the message containing an event that defines the meaning of the message and, consequently, the process to be applied.

13. The method as claimed in claim 12, characterized in that said message represents a form that combines all the information needed for a process to be carried out, by all the computer applications likely to be implemented in relation to the primary document.

14. The method as claimed in any one of claims 11 to 13, characterized in that it includes a step for the issuing, by said application, when it has completed the process, of another message addressed to another computer application, this other message containing an event that defines the meaning of this other message and, consequently, the process to be applied, and said form.

15. The method as claimed in any one of claim 13 or 14, characterized in that the form contains a typical document associated with the user.

16. The method as claimed in any one of claims 11 to 15, characterized in that it includes, in order to implement the step for use of a coupon, a step for displaying a management desk, a workspace in which the user can perform management acts and a step for displaying a correspondence desk, in which the user can obtain reports of operations carried out in accordance with his or her instructions or of operations that concern him or her, and access a log of these operations.

17. The method as claimed in any one of claims 11 to 16,
characterized in that it includes a step for the issuing of a certificate of conformity intended for the correspondence desk, by each application involved in an operation of a process initiated by a coupon.

18. The method as claimed in any one of claims 11 to 17, characterized in that it includes, for a dematerialization coupon of a document:
a step for issuing an original document,
a step for retaining the original in a secure memory,
a switching step, that is to say a step for duplicating the original in a memory assigned to the issuing user and in a memory assigned to each recipient, and
a step for exemplifying, that is to say enclosing, electronically or in hard copy form, each copy of the original assigned to a recipient.

19. The method as claimed in any one of claims 11 to 18, characterized in that, during the step for determining the content of a document, a complete bill of materials of the components of the common language that are used for all the messages exchanged in relation to this document is implemented.

20. The method as claimed in claim 19, characterized in that the bill of materials consists of typical events, typical forms and typical documents.

21. The method as claimed in any one of claims 11 to 20, characterized in that an event represents one of the following management acts:
a manufacturing order,
an original issue,
a bill acceptance,
an acknowledgement of receipt or
a payment order.

22. The method as claimed in any one of claims 11 to 21, characterized in that, during the life of the document, the form is documented at each step of the process by the result of the processing of said step.

23. The method as claimed in any one of claims 11 to 22, characterized in that, during the step for determining the content of the document, reference is made to a typical document which defines the structure of the document, the authorizations and the management decisions, or coupons, attached to the document.

24. A device for processing information, characterized in that it comprises:
a means of determining the content of a so-called primary document containing at least one definition of at least one so-called “secondary” document linked to said primary document and
a means of creating a secondary document, the content of said secondary document being automatically dependent on the content of the primary document.
